(19) United States
(12) Patent Application Publication
(10) Pub. No.: US 2008/0291879 A1
(43) Pub. Date: Nov. 27, 2008

(54) Man-Portable Incident Command Platform

(76) Inventors: Adam C. Duff, Nashua, NH (US); Thomas M. Duff, JR., Nashua, NH (US); Jerard I. Herman, Nashua, NH (US); Brendan Reilly, Westport, CT (US)

Correspondence Address: RYAN, MASON & LEWIS, LLP, 1300 POST ROAD, SUITE 205, FAIRFIELD, CT, 06824, US

(21) Appl. No.: 11/752,033

(22) Filed: May 22, 2007

(51) Int. Cl. H04Q 7/24; H02J 1/00; H02J 7/02; H02J 7/04

(52) U.S. Cl. 370/338; 307/11; 320/137; 320/150

(57) ABSTRACT

A man-portable incident command platform is provided. A controller for a rechargeable battery system is disclosed that evaluates whether a cover of the rechargeable battery system is open or closed; determines whether an AC power source is available; evaluates a charge level (for example, from a system management bus) of one or more batteries in the rechargeable battery system; and enables a charging circuit for one or more batteries requiring a charge based on whether the cover of the rechargeable battery system is open or closed and if the AC power source is available A charging circuit for the rechargeable battery system is disclosed that comprises one or more programmable voltage sources for charging one or more batteries in the rechargeable battery system. A power distribution unit (PDU) is disclosed for a rechargeable battery system that supplies power to a plurality of devices each having a different voltage requirement The PDU comprises a plurality of DC/DC converters for converting a first DC value to a plurality of DC levels, wherein each of the plurality of DC levels are associated with a different one of the voltage requirements. A portable communications device is disclosed that comprises a plurality of wireless backhaul connections to a public network; and a mobile mesh network connection for establish a wireless local area network.

### FIELD OF THE INVENTION

The present invention relates generally to communications and computer platforms, and more particularly, to portable command centers.

### BACKGROUND OF THE INVENTION

Following a catastrophic event, such as a significant emergency or natural disaster, power failures often occur and communication services are often not available Thus, emergency responders and other key personnel are often unable to communicate at such a critical time, thereby inhibiting any recovery efforts. The ability to communicate with other responders or to access important data is critical during such moments of crisis.

A number of portable command centers exist that can be deployed in a region that has experienced a catastrophic event in order to assist the recovery efforts Typically, existing portable command centers are based on a truck or another vehicle platform that can transport the required battery operated communications and computer equipment to the site of the crisis Thus, the cost of such vehicle-based solutions is often prohibitive. In addition, due to the high costs of such solutions, each vehicle is typically responsible for a wide geographic area and may not be in close proximity to a given area when a disaster occurs

A need therefore exists for improved portable command centers. A further need exists for man-portable command centers that can be easily distributed and stored for use in the event of a catastrophic event. Yet another need exists for improved portable command centers that allow emergency responders and other key personnel to communicate and take command of a challenging situation, even in hostile or remote environments when infrastructure no longer exists.

### SUMMARY OF THE INVENTION

Generally, the present invention provides a man-portable incident command platform. According to one aspect of the invention, the incident command platform includes a controller for a rechargeable battery system. The controller evaluates whether a cover of the rechargeable battery system is open or closed; determines whether an AC power source is available; evaluates a charge level (for example, from a system management bus) of one or more batteries in the rechargeable battery system; and enables a charging circuit for one or more batteries requiring a charge based on whether the cover of the rechargeable battery system is open or closed and if the AC power source is available The controller is further configured to monitor a temperature of the rechargeable battery system while the charging circuit is enabled The controller can optionally keep track of a number of charge cycles for the one or more batteries in the rechargeable battery system. The controller can enable a charge of the one or more batteries if the AC power is present and to operate from line power if the AC power is present and the cover of the rechargeable battery system is opened.

According to a further aspect of the invention, the incident command platform includes a charging circuit for the rechargeable battery system, comprising one or more programmable voltage sources for charging one or more batteries in the rechargeable battery system. The charging optionally contains one or more switches for selecting between battery power or line power. The charging circuit can include one or more devices to prevent the one or more batteries from discharging into a voltage source when line power is being employed or into the one or more programmable voltage sources when the one or more batteries are not being charged The charging circuit can also include one or more devices to establish a current limit for the one or mole batteries

According to yet another aspect of the invention, the incident command platform includes a power distribution unit for the rechargeable battery system. The rechargeable battery system supplies power to a plurality of devices each having a different voltage requirement. The power distribution unit comprises a plurality of DC/DC converters for converting a first DC value to a plurality of DC levels, wherein each of the plurality of DC levels are associated with a different one of the voltage requirements The DC/DC converters allow the line adapters of the plurality of devices to be removed. The power distribution unit optionally includes an AC/DC converter to translate a universal power source to the first DC value The AC/DC converter optionally provides sufficient power to simultaneously recharge one or more batteries in the rechargeable battery system and to operate the plurality of devices. The power distribution unit may include a power factor correction (PFC) stage that ensures that the AC voltage and current signals are phase aligned for the plurality of devices. One or more of the batteries can preferably be replaced while the rechargeable battery system is providing a voltage to a load According to a further aspect of the invention, the incident command platform includes a portable communications device that comprises a plurality of wireless backhaul connections to a public network; and a mobile mesh network connection for establish a wireless local area network. The plurality of wireless backhaul connections to a public network comprises, for example, a connection over a satellite network and a cellular network. The portable communications may also include at least one independent wireless local area network in addition to the mobile mesh network A router can select one of the wireless local area networks or one of the plurality of wireless backhaul connections. The portable communications device can optionally bridge a plurality of RF frequencies.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is a schematic block diagram illustrating the incident command platform in further detail;

FIG. 3 is a schematic block diagram of a power distribution unit incorporating features of the present invention;

FIG. 4 illustrates the AC/DC converter of FIG. 3 in further detail;

FIG. 5 illustrates the second DC/DC converter of FIG. 3 in further detail;

FIG. 6 is a circuit diagram for an exemplary implementation of the battery charger of FIG. 3; and

FIGS. 7A and 7B, collectively, illustrate pseudo-code incorporating features of the present invention for an exemplary implementation of the case controller of FIG. 3.

### DETAILED DESCRIPTION

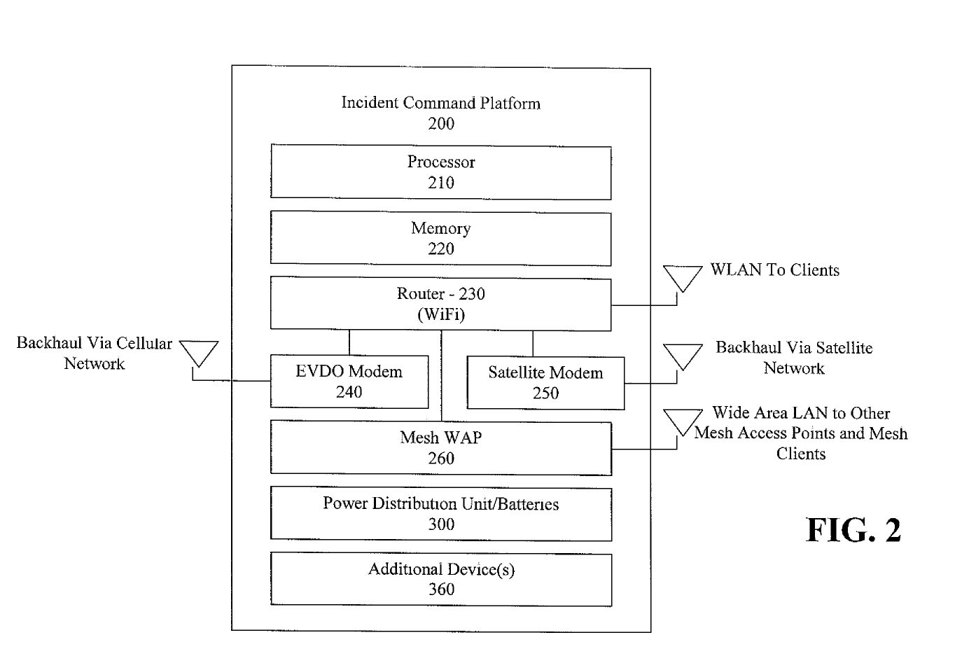

The present invention provides an incident command platform 200, discussed further below in conjunction with FIG. 2, that in one preferred embodiment is a man-portable, battery powered, command, control, communications and computing network platform. The incident command platform 200 can preferably be deployed by a single user to create an independent, self-configuring, standards-based, non-line-of-sight, wireless network with a coverage radius of up to, for example, 7 miles (configuration and terrain dependent). The incident command platform 200 allows a user to make a telephone call, establish a network connection, participate in a video teleconference, access remote data and to take command of a challenging situation, even in hostile or remote environments when infrastructure no longer exists

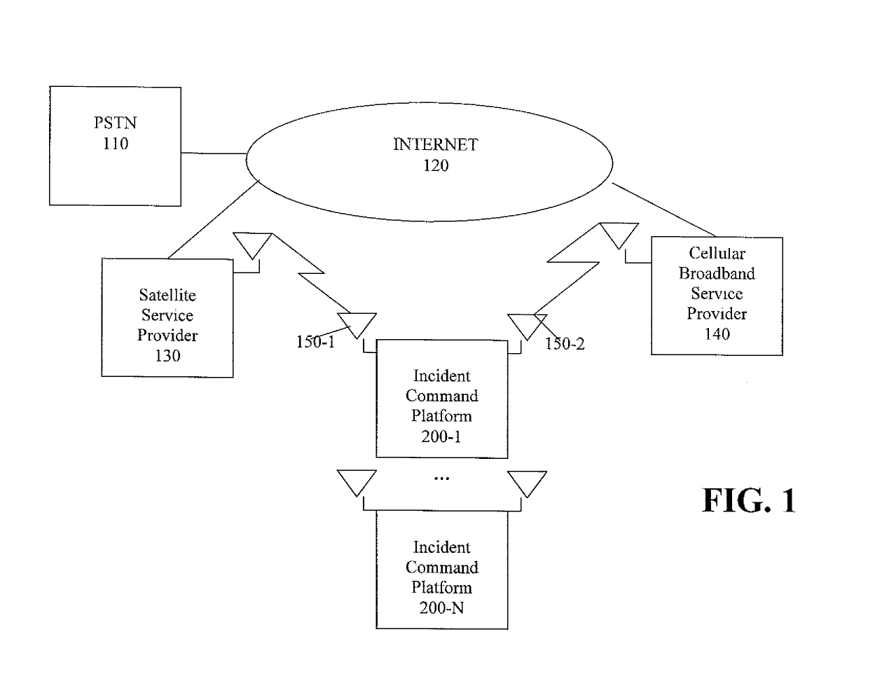

FIG. 1 illustrates a network environment in which the present invention can operate. As shown in FIG. 1, the incident command platform 200 provides one or more wireless communication capabilities 150, discussed further below in conjunction with FIG. 2, that allow the incident command platform 200 to establish a connection, for example, to one or more of a satellite service provider 130 and a cellular service provider 140. The satellite service provider 130 and cellular service provider 140 allow the incident command platform 200 to establish a connection to the Internet 120, Public Switched Telephone Network (PSIN) 110, or another public or wide area network (not shown).

FIG. 2 is a schematic block diagram illustrating the incident command platform 200 in further detail. As shown in FIG. 2, the incident command platform 200 includes a memory 210 and a processor 220. The memory 210 configures the processor 220 to implement the methods, steps, and functions disclosed herein The memory 210 could be distributed or local and the processor 220 could be distributed or singular. The memory 210 could be implemented as an electrical, magnetic or optical memory, or any combination of these or other types of storage devices. It should be noted that each distributed processor that makes up processor 220 generally contains its own addressable memory space It should also be noted that some or all of computer system 200 can be incorporated into a personal computer, laptop computer, handheld computing device, application-specific circuit or general-use integrated circuit.

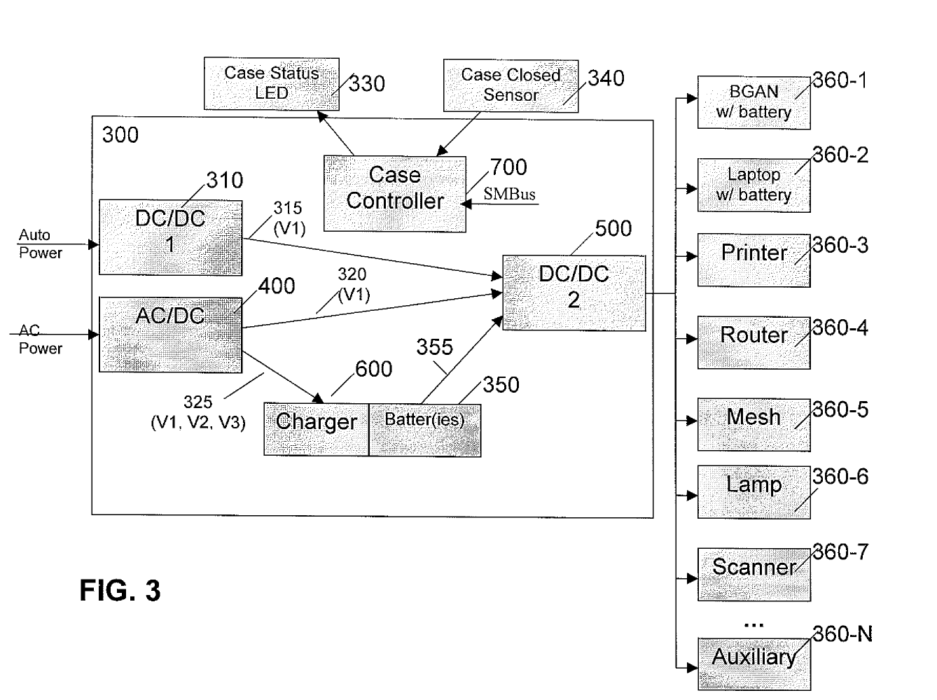

The incident command platform 200 also includes a power distribution unit (and batteries) 300 and additional devices 360, each discussed further below in conjunction with FIG. 3.

### Network Capabilities

As shown in FIG. 2, the exemplary incident command platform 200 includes a router 230, Evolution Data Only (EVDO) modem 240 (an optimized version of CDMA 2000 for broadband connection via cellular network), satellite modem 250 (for broadband connection via satellite network), and a mesh wireless access point (WAP) 260

The exemplary incident command platform 200 optionally provides two or more methods for establishing a local area network (LAN) For example, the exemplary router 230 optionally provides a Wireless Fidelity (WiFi) network, for example, in accordance with an IEEE 802.11 wireless networking standard. In addition, the mesh WAP 260 allows a mesh network to be established that provides coverage, for example, of up to two miles depending on terrain and the physical environment. The range of the mesh network can be extended by employing additional mesh access points. Thus, each mesh WAP 260 can provide connections to additional mesh access points for extended range, as well as to mesh clients In this manner, the scope or range of the mesh network can optionally be extended, as needed based on the geographic scope of the incident that the incident command platform 200 is supporting.

The mesh WAP 260 may be embodied, for example, based on one or more of the following references, http://w3.antd.nist gov/wctg/netanal/netanal_netmodels html#MESH; http://en wikipedia.org/wiki/Wireless_mesh_network;http://en wikipedia.org/wiki/IEEE_{—}802.11s; or International Patent No. WO9608884A1, entitled “Massive Array Cellular System,” each incorporated by reference herein. The mesh WAP 260 allows mobile wireless communications. The mesh WAP 260 provides reliable routing even when one or more network nodes or client devices are moving. The mesh WAP 260 is capable of carrying multimedia data, including video, voice and data and optionally supports encryption. The mesh network is preferably self healing, ad-hoc and self-configuring, in a known manner. For a more detailed discussion of wireless mesh networks, see, for example,

The exemplary incident command platform 200 also optionally provides two or more methods for establishing redundant wireless backhaul connections to the Internet or another public network. As shown in FIG. 2, the exemplary incident command platform 200 provides an EVDO modem 240 for a backhaul connection via the cellular telephone network and a satellite modem 250 for a backhaul connection via a satellite network. The satellite modem 250 and antenna are configured and aligned in a known manner. The satellite modem 250 may communicate, for example, with the Broadband Global Area Network (BGAN) which uses land portable terminals such as the Thrane Explorer 300/500/700 to provide “always-on” communications. In this manner, the Thrane BGAN brings an IP services environment to almost any remote location to achieve a bandwidth of up to 464 kbps The Thrane 300/500 terminal can provide up to 128 kbps of Quality of Service (QoS) streaming services. The Thrane 700 terminal can provide up to 256 kbps of QoS streaming services.

The incident command platform 200 optionally supports a number of Radio Frequencies (RF) including 800-900 Mhz, 1800-1900 Mhz, 2.4-2.5 Ghz, 4.9 Ghz, and 5.725-5.85 Ghz. The router 230 and mesh WAP 260 optionally support 2.4 GHz and the mesh WAP 260 supports, for example, 4 9, 5.4 and 5.8 GHz The mesh WAP 260 provides a multiple-frequency bridge that allows devices operating at different frequencies to communicate. The incident command platform 200 provides a backhaul fur all frequencies.

The priority among the redundant LAN connections and redundant backhaul connections can be established programmatically in the router 230 through configuration or by means of a pre-defined default priority (such as WiFi, if available, before Mesh, and EVDO, if available, before satellite). In additional the priority of the redundant LAN and backhaul connections can be manually adjusted through switch control or powering off a given device.

### Power Management

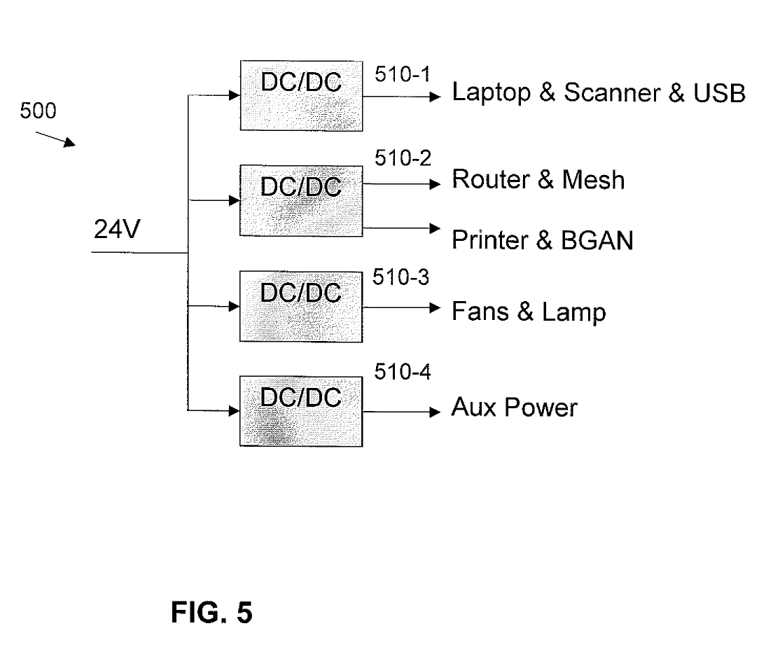

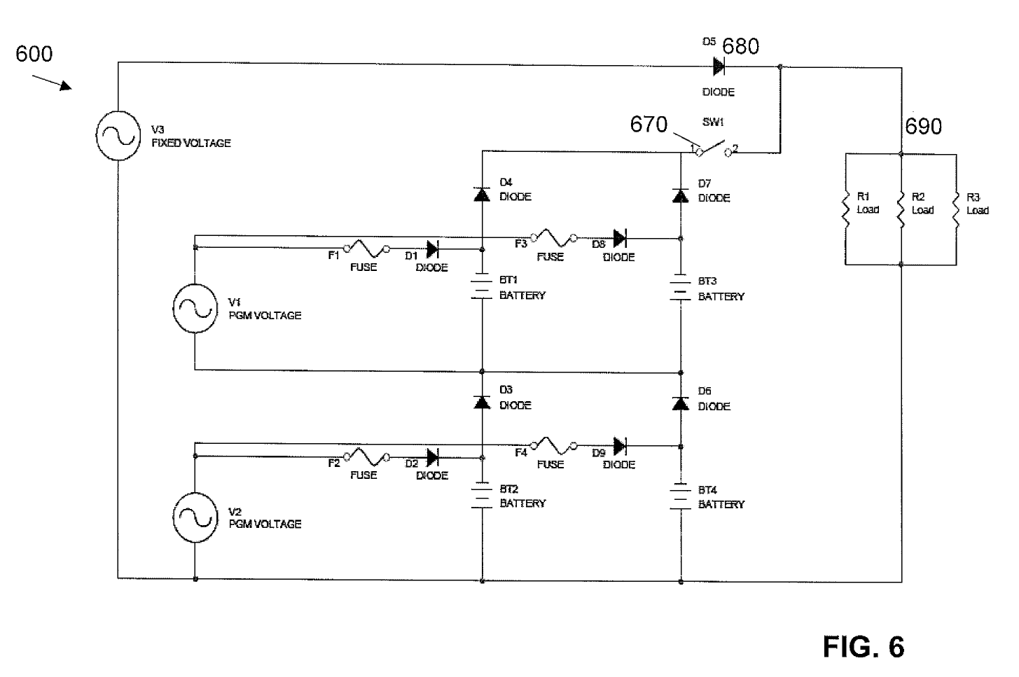

FIG. 3 is a schematic block diagram of a power distribution unit 300 incorporating features of the present invention As shown in FIG. 3, the power distribution unit 300 includes a first DC/DC converter 310 Generally, the first DC/DC converter 310 provides a vehicle power conversion function. In one exemplary implementation, the first DC/DC converter 310 operates from a 10V to 36V source voltage to provide operating power at 24 Volts. The first DC/DC converter 310 requires a direct connection to a vehicle power system (generally more than a lighter socket) The 24V generated by the first DC/DC converter 310 is provided by means of a connection 315 to a second DC/DC converter 500, discussed further below in conjunction with FIG. 5, as operating power (as opposed to the power source used to recharge the one or more rechargeable batteries 350 in the incident command platform 200). The power distribution unit 300 includes a battery charger 600, discussed further below in conjunction with FIG. 6 for charging the batteries 350

Generally, the second DC/DC converter 500 converts the 24V operating power to a number of different voltages, as required by each of the various devices 360-1 through 360-N that are included in the incident command platform 200. In the exemplary implementation shown in FIG. 3, the incident command platform 200 includes a BGAN modem 360-1 (the satellite modem 250), a laptop 360-2, a printer 360-3, a router 360-4 (shown as router 230 in FIG. 2), mesh WAP 360-5 (shown as element 260 in FIG. 2), a lamp 360-6, a scanner 360-7, and one or more auxiliary devices 360-N. The BGAN modem 360-1 and laptop 360-2 devices include dedicated batteries, and can also operate on the power provided by the incident command platform 200

The batteries 350 provide portable power and may be implemented, for example, as military style rechargeable batteries, such as Lithium-Ion batteries, with two 14.4V cells per battery. In one exemplary implementation, the batteries 350 provide 6.8 Ah at 28.8V. The operating temperature range for one suitable battery type 350 may be, for example, −20 to +55° C. (−4 to +131° F.). The batteries 350 preferably have internal safety circuits, rated for aircraft transport.

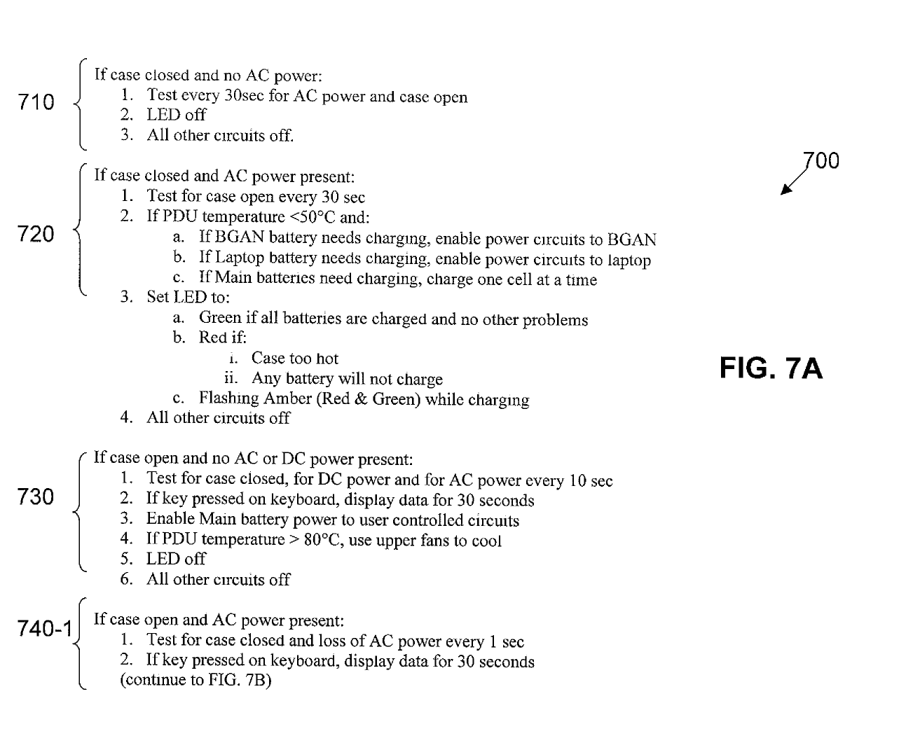

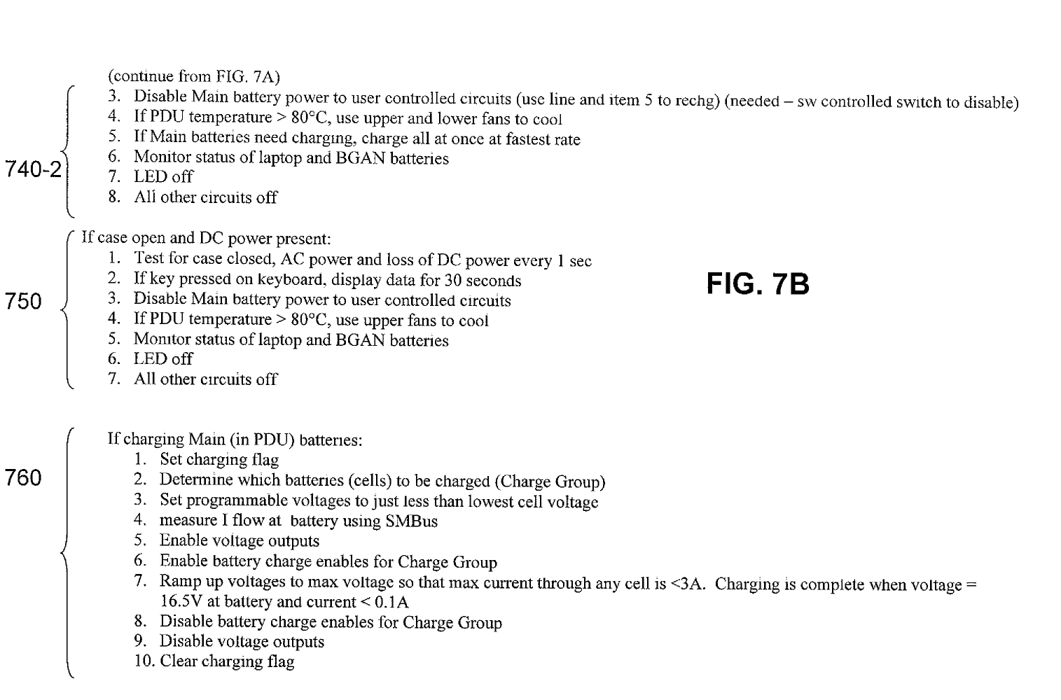

According to one aspect of the present invention, the batteries 350 contain a System Management Bus (SMBus) (not shown) that provides smart control and monitoring. Generally, an SMBus is an industry standard bus for batteries and typically reports Voltage, Current, charge completion flag, charge percentage and temperature. As discussed further below in conjunction with FIG. 7, the battery data is provided to a case controller 700 that provides power management and controls the recharging of the batteries. As discussed hereinafter, the case controller 700 controls an LCD display that indicates the status of the batteries. In addition, the case controller 700 also receives a signal from a case closed sensor 340 indicating whether the case cover for the incident command platform 200 is open or closed.

As shown in FIG. 3, the power distribution unit 300 also includes an exemplary AC/DC converter 400 that operates from a universal AC source (such as 85-265 Vac, 47-63 Hz, 1Ø) to provide operating power on a connection 320, for example, at 24V, as well as two programmable voltage outputs on a connection 325 for battery charging.

As shown in FIG. 3, the second DC/DC converter 500 receives the operating power (such as 24V) from connections 315, 320, when available, and also receives batter power via a connection 355 from the batteries 350.

According to another aspect of the present invention, one or more batteries can be swapped while the incident command platform 200 is operating (sometimes referred to as a “hot swap”). Thus, the power distribution unit 300 optionally incorporates the appropriate mechanical and electrical design features to allow one or more batteries to be swapped while the incident command platform 200 is operating. Mechanically, the “hot swap” design requires that one or more batteries can be physically removed without disturbing the other batteries (without disconnecting the circuit for the other batteries). In this manner, the incident command platform 200 can operate on one battery or multiple batteries. In addition, as long as one battery is charged and remains active, the other batteries can be removed without disturbing the battery source.

Electrically, the “hot swap” design requires that the batteries are connected in parallel In addition, as discussed further below in conjunction with FIG. 6, the “hot swap” design requires one or more fuses or similar protection to protect each battery from current surges For example, if a discharged battery is inserted into the power distribution unit 300, the dead battery can be damaged or become a safety or fire hazard if there is a current surge from the remaining charged batteries

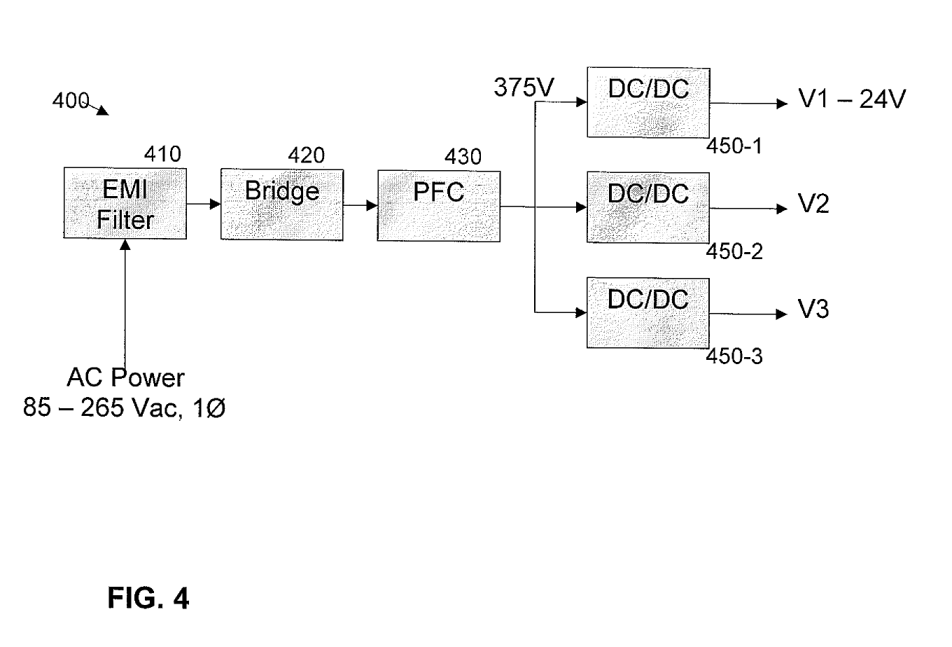

FIG. 4 illustrates the AC/DC converter 400 of FIG. 3 in further detail. The AC/DC converter 400 operates from a universal AC source to provide the operating power, for example, at 24V, as well as the two programmable voltage outputs for battery charging. As previously indicated, the universal AC source may be, for example, 85-265 Vac. In this manner, the AC/DC converter 400 can provide enough power to operate the various devices 360, as well as to charge the batteries 350 Thus, the batteries 350 can be charged directly in the incident command platform 200.

As shown in FIG. 4, the AC power is applied to an electromagnetic interference filter 410 and then the filtered AC power is applied to a bridge 420. The EMI filter 410 provides EMI filtering, for example, in the United States per Federal Communications Commission (FCC), Part 15 Class A

A power factor collection (PFC) stage 430 applies active PFC to meet, for example, an International Electrotechnical Commission (IEC) Harmonic Distortion specification. Generally, the power factor correction (PFC) stage 430 ensures that the AC voltage and current signals are phase aligned and generates a DC voltage In this manner, the incident command platform 200 ensures that the PFC governmental or regulatory requirements ale satisfied for the aggregated devices 360 in the incident command platform 200. The exemplary AC/DC converter 400 includes three DC/DC converters 450-1 through 450-3. The DC/DC converters 450-1 through 450-3 generate the voltages V1 (used to power the DC/DC converters (500) (FIG. 5)), and V2 and V3 (employed by the battery charger 600 (FIG. 6)).

FIG. 5 illustrates the second DC/DC converter 500 of FIG. 3 in further detail. Generally, the second DC/DC converter 500 converts the operating power (24V) to provide the various voltages that operate the various devices 360 The second DC/DC converter 500 operates from 24V source to provide up to 240 W of power at various voltages in an exemplary embodiment. As shown in FIG. 5, the exemplary second DC/DC converter 500 includes a number of different DC/DC converters 510-1 through 510-4 that each generates a different DC voltage level.

In the exemplary implementation of FIG. 5, the first DC/DC converter 510-1 generates a voltage level for the laptop, scanner and USB devices 360. The second DC/DC converter 510-2 generates voltage levels for the router and mesh WAP devices 360, as well as the printer and BGAN (satellite) modem devices. The third DC/DC converter 510-3 generates a voltage level for the fan and lamp devices 360. Finally, the fourth DC/DC converter 510-4 generates one or more voltage levels as auxiliary power. As previously indicated, the power distribution unit 300 includes an SMBus for monitoring the state of the batteries 350. The second DC/DC converter 500 also monitors the power to the dedicated BGAN (satellite) modem and laptop batteries.

According to one aspect of the present invention, the different DC voltage levels generated by the second DC/DC converter 500 allow the AC adapters and related cables of the various devices 360 to be removed In this manner, significant space and power savings can be achieved

FIG. 6 is a circuit diagram for an exemplary implementation of the battery charger 600 of FIG. 3. As previously indicated, the battery charger 600 charges the batteries 350. According to one aspect of the present invention, the battery charger 600 employs programmable voltage sources and directs programmable voltage outputs to the appropriate batteries for charging (i.e, the one or more batteries most needing a recharge). The exemplary battery charger 600 supports up to four batteries with two 14.8V cells each, but the battery charger 600 can be extended for additional batteries as would be apparent to a person of ordinary skill in the art, based on the discussion herein. Thus, in the exemplary embodiment of FIG. 6, a first battery is comprised of cells BI1, BI2, and a second battery is comprised of cells BI3, BI4. If each cell is 12V, for example, then the series combination of cells provides 24V. As indicated above, the voltages V1, V2, V3 are generated by the AC/DC converter 400. Generally, a programmable voltage source V2, V3 is required for each cell in a battery.

As shown in FIG. 6, the battery charger 600 includes a switch 670 that allows the case controller 700 to select between line power (V3) or battery power from the batteries BI1-BI4 to power the load 690 (such as the devices 360). The switch 670 prevents the batteries BI1-BI4 from discharging when the AC power V3 is present. The battery charger 600 also includes a diode D5 so that when the batteries are enabled and operational via switch 670, the batteries BI1-BI4 do not discharge back into the voltage source V3, due to the parasitic characteristics of the source V3

The battery charger 600 includes fuses F1-F4 to limit the current drawn by the corresponding battery BI1-BI4 In this manner; the batteries BI1-BI4 cannot draw too much current to damage the batteries or become a safety hazard For example, the fuses F1-F4 can limit the charging current per cell to 3A for a safe, but quick, charge. As discussed above, the fuses F1-F4 also support the “hot swap” aspects of the battery system design. The battery charger 600 also includes diodes D1, D2, D8, D9 to prevent the corresponding batteries BI1-BI4 from discharging back into the voltage sources V1, V2 when the batteries BI1-BI4 are not being charged. If the voltage sources V1, V2 are not supplying a voltage to the batteries BI1-BI4, then the parasitic characteristics of the voltage sources V1, V2 would otherwise drain the batteries BI1-BI4 over time Finally, the battery charger 600 includes diodes D3, D4, D6, D7 to isolate the two cells in a given battery, such as BI1 and BI2, as well as the two voltage sources V1, V2.

The recharging of the batteries BI1-BI4 is managed by the case controller 700, in a manner discussed below in conjunction with FIG. 7. Generally, the case controller 700 monitors the battery statistics on the SMBus and determines when the batteries BI1-BI4 require a recharge. The case controller 700 will enable the charging circuit when a recharge is required and control the programmable voltages V2, V3 to charge the batteries BI1-BI4. The programmable voltages are adjusted to keep the current drawn by the batteries from getting too high, as discussed further below.

The batteries BI1-BI4 are charged by adjusting the programmable voltage associated with the battery cell (and not the current). In this manner, excess energy and heat are reduced relative to conventional techniques. For example, if a conventional technique employed a 16 5V power supply limited to 3 amps to charge, the supply is generating 50 W of power. If the battery, however, is only drawing 3 amps at 10 V, only 30 W are absorbed by the battery itself, and the remaining energy needs to be absorbed.

The present invention, on the other hand, can generate 33 W (3 amps at 11 V). Thus, only 3 W of excess thermal energy needs to be absorbed. The present invention initially sets the programmable voltages to just below the lowest measured cell voltage and then gradually increases the applied voltage (V2, V3) using the programmable voltage source. Since the voltage level is applied only when needed and is set to a minimum value and increased only as needed, it thereby provides a more efficient charging process. In addition, the gradual increase of the applied voltage (V2, V3) allows the batteries BI1-BI4 that most require the recharge (i.e, those with lowest measured voltage) to be charged first. For example, if a first battery has a measured discharge state of 10 V (and a fully charged state of 16.5V) and the remaining batteries BI1-BI4 have a charge of 14V, only the first battery will be charged as the applied voltage (V2, V3) is set to just less than 10V and then gradually exceeds 10V (for example, in 100 mV increments), until the applied voltage (V2, V3) is increased to 14V when all the batteries BI1-BI4 will be charged. Any battery that has a measured voltage above the current programmed charge voltage level will not be charged until the charge voltage is above the measured internal battery voltage. As the programmable voltage is increased, the current is monitored and the voltage is increased until the current drawn by the battery is 3 A, in the exemplary embodiment (3 A current limit). As the current drops off, the voltage is increased, up to a maximum voltage level.

FIGS. 7A and 7B, collectively, illustrate pseudo-code incorporating features of the present invention for an exemplary implementation of the case controller 700 of FIG. 3 Generally, the exemplary case controller 700 provides microprocessor control of all case functions For example, as indicated above, the case controller 700 monitors the status of the batteries, including the laptop and BGAN batteries, and optionally displays the battery status on an LCD display. In addition, the case controller 700 controls the programmable voltage outputs (V2, V3) to charge the batteries BI1-BI4 in shortest time. As discussed hereinafter, the case controller 700 monitors the case Open/Closed status and power circuit status to minimize the load on the batteries and control the case temperature. Among other benefits, the case controller 700 supports the charging of the batteries BI1-BI4 with the case closed, and also displays the case status with the case closed. The exemplary case controller 700 also monitors the case temperature and controls internal fans.

As shown in FIG. 7A, the case controller 700 includes a section of code 710 (System Off) that is implemented when the case is closed and there is no AC power The code 710 periodically reevaluates whether there is AC power and the case has been opened. While the case remains closed and there is no AC power, the code 710 shuts off the LED indicators and all other circuits.

The case controller 700 includes a section of code 720 (Battery Recharge; System Off) that is implemented when the case is closed and there is AC power present The code 720 periodically reevaluates whether the case has been opened. If temperature of the power distribution unit 300 is below, for example, 50° C., the code 720 enables the power circuits to the BGAN modem, laptop and main batteries 350, if needed In addition, the code 720 sets the LED indicators to green, if all batteries are charged and no other problems; to led if the case temperature exceeds a predefined threshold, or any battery will not charge; or to a flashing Amber (Red & Green) while charging All other circuits are turned off.

The case controller 700 includes a section of code 730 (Battery Operation) that is implemented when the case is open and there is no AC or DC power present. The code 730 periodically tests to determine if the case was closed, and for DC power and for AC power. If a key is pressed on the keyboard, the data is displayed for 30 seconds. The main battery power is enabled to user controlled circuits. The code monitors the temperature of the power distribution unit 300 and enables the fins if the temperature exceeds a threshold. The LED indicators and all other circuits are turned off.

The case controller 700 includes a section of code 740 (AC Power Operation) that is implemented when the case is open and there is AC power present. The code 740 periodically tests to determine if the case was closed, and for loss of AC power If a key is pressed on the keyboard, the data is displayed for 30 seconds. The main battery power is disabled to the user controlled circuits. The code 740 monitors the temperature of the power distribution unit 300 and enables one or more fans if the temperature exceeds a threshold If the main batteries need charging, they are charged all at once, preferably at fastest rate. The status of the laptop and BGAN batteries are also monitored. The LED indicators and all other circuits are turned off.

The case controller 700 includes a section of code 750 (DC Power Operation) that is implemented when the case is open and DC power is present. The code 750 periodically tests to determine if the case was closed, and for loss of DC power. If a key is pressed on the keyboard, the data is displayed for 30 seconds The main battery power is disabled to the user controlled circuits The code 750 monitors the temperature of the power distribution unit 300 and enables one or more fans if the temperature exceeds a threshold. The status of the laptop and BGAN batteries are monitored. The LED indicators and all other circuits are turned off.

The case controller 700 includes a section of code 760 (Main Battery Charging) that is implemented when the main batteries are being charged (if charging with the case closed, the charge group will be one cell). The code 760 sets the charging flag (and increments a charge counter for the battery) and then determine which batteries to be charged (i.e., the Charge Group) The programmable voltages are set to just less than the lowest measured cell voltage in the Charge Group for each charge path The voltage outputs are enabled and the battery charge is enabled for the Charge Group. The voltages ate increased to a maximum voltage so that the maximum current through any cell remains below 3 A. Charging is complete when the measured battery voltage is 16.5V and the current is below 0.1 A. The battery charge enables are disabled for the Charge Group and the voltage outputs are then disabled.

For batteries having a limited number of charge cycle, it the charging flag counter exceeds a predefined threshold for a given battery, a warning indicator or message can optionally be presented.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to 30 perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the su face of a compact disk.

The computer systems and servers described herein each contain a memory that will configure associated processors to implement the methods, steps, and functions disclosed herein. The memories could be distributed or local and the processors could be distributed or singular The memories could be implemented as an electrical, magnetic or optical memory, or any combination of these or other types of storage devices Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A controller for a rechargeable battery system, comprising:
a memory that stores computer-readable code; and
a processor operatively coupled to the memory, said processor configured to implement the computer-readable code, said computer-readable code configured to:
evaluate whether a cover of said rechargeable battery system is open or closed;
determine whether an AC power source is available;
evaluate a charge level of one or more batteries in said rechargeable battery system; and
enable a charging circuit for one or more batteries requiring a charge based on whether said cover of said rechargeable battery system is open or closed and if said AC power source is available.

2. The controller of claim 1, wherein said processor is further configured to monitor a temperature of said rechargeable battery system while said charging circuit is enabled.

3. The controller of claim 1, wherein said processor is further configured to establish one or more visual indicators in a predefined state if one or more batteries in said rechargeable battery system are charged.

4. The controller of claim 1, wherein said processor evaluates said charge level by evaluating one or more battery parameters on a system management bus

5. The controller of claim 1, wherein said processor is further configured to keep track of a number of charge cycles for said one or more batteries in said rechargeable battery system

6. The controller of claim 1, wherein said enabled charging circuit activates one or more programmable voltage sources

7. The controller of claim 1, wherein said processor is further configured to enable a charge of said one or more batteries if said AC power is present and to operate from line power if said AC power is present and said cover of said rechargeable battery system is opened.

8. The controller of claim 1, wherein said processor is further configured to enable said one or more batteries if said cover of said rechargeable battery system is opened and no external power is available.

9. A charging circuit for a rechargeable battery system, comprising:
one or more programmable voltage sources for charging one or more batteries in said rechargeable battery system

10. The charging circuit of claim 9, further comprising one or more switches for selecting between battery power or line power

11. The charging circuit of claim 9, further comprising one or more devices to prevent said one or more batteries from discharging into a voltage source when line power is being employed.

12. The charging circuit of claim 9, further comprising one or more devices to prevent said one or more batteries from discharging into said one or more programmable voltage sources when said one or more batteries are not being charged.

13. The charging circuit of claim 9, further comprising one or more devices to establish a current limit for said one or more batteries.

14. The charging circuit of claim 9, wherein said one or more programmable voltage sources are initially set to a value below a minimum charge level of said one or more batteries in said rechargeable battery system and then a voltage level of said one or more programmable voltage sources is increased.

15. A power distribution unit for a rechargeable battery system that supplies power to a plurality of devices each having a different voltage requirement, comprising:
a plurality of DC/DC converters for converting a first DC value to a plurality of DC levels, wherein each of said plurality of DC levels are associated with a different one of said voltage requirements.

16. The power distribution unit of claim 15, wherein said plurality of DC/DC converters allow the line adapters of said plurality of devices to be removed.

17. The power distribution unit of claim 15, further comprising an AC/DC converter to translate a universal power source to said first DC value.

18. The power distribution unit of claim 17, wherein said AC/DC converter provides sufficient power to simultaneously recharge one or more batteries in said rechargeable battery system and to operate said plurality of devices

19. The power distribution unit of claim 15, further comprising an electromagnetic interference filter.

20. The power distribution unit of claim 15, hither comprising a power factor correction (PFC) stage for ensuring that the AC voltage and current signals are phase aligned for said plurality of devices.

21. The power distribution unit of claim 15, wherein said rechargeable battery system comprises a plurality of batteries and wherein one or more of said batteries can be replaced while said rechargeable battery system is providing a voltage to a load.

22. A portable communications device, comprising:
a plurality of wireless backhaul connections to a public network; and
a mobile mesh network connection for establish a wireless local area network.

23. The portable communications device of claim 22, wherein said plurality of wireless backhaul connections to a public network comprises a connection over a satellite network.

24. The portable communications device of claim 22, wherein said plurality of wireless backhaul connections to a public network comprises a connection over a cellular network.

25. The portable communications device of claim 22, further comprising at least one independent wireless local area network in addition to said mobile mesh network.

26. The portable communications device of claim 25, further comprising a touter for selecting one of said wireless local area networks.

27. The portable communications device of claim 22, further comprising a router for selecting one of said plurality of wireless backhaul connections.

28. The portable communications device of claim 27, wherein said router selects one of said plurality of wireless backhaul connections based on one or more of configuration information, a pre-defined default priority or a manual selection.

29. The portable communications device of claim 22, further comprising means for bridging a plurality of RF frequencies.
